(19) United States
(12) Patent Application Publication
(10) Pub. No.: US 2026/0192323 A1
(43) Pub. Date: Jul. 9, 2026

(54) DEVICE, USE AND METHOD FOR DOSING OR LEVELLING

(71) Applicant: VOITH PATENT GMBH, Heidenheim (DE)

(72) Inventor: Benjamin MENDEZ-GALLON, Königsbronn (DE)

(21) Appl. No.: 18/866,771

(22) PCT Filed: Apr. 4, 2023
(86) PCT No.: PCT/EP2023/058787

§ 371 Date: Jan. 30, 2025

(30) Foreign Application Priority Data
May 19, 2022 (DE) 10 2022 112 542.4
Oct. 11, 2022 (DE) 10 2022 126 270.7

(51) Int. Cl. B05C 11/02

(52) U.S. Cl. CPC B05C 11/025

(57) ABSTRACT

A device and a method for dosing or levelling a liquid or pasty application medium onto a moving surface include a dosing element for contacting the application medium in a contact zone, and a contact pressure unit for pressing the dosing element against the moving surface. The dosing element is formed wholly or partly of a magnetic or ferromagnetic material. The device also includes at least one magnetic element which is positioned in such a way that the magnetic force between the pressing unit and the contact zone, in particular in the region of the contact zone, acts on the dosing element.

The invention relates to a device for dosing or levelling a liquid or pasty application medium onto a moving surface according to the preamble of claim 1, and to a corresponding method and a use.

In the finishing of fibrous material webs, for example in the coating or gluing of webs of paper, cardboard and packaging material, liquid or pasty application media are frequently applied as thin liquid films to the fibrous material web or a transfer surface. In general, these film thicknesses are in the range from 1 μm to 100 μm. These application media can be dosed using either volumetric or hydrodynamic dosing principles.

Dosing can be accomplished, for example, using the dosing devices known from EP 1761341 B1 and WO 02/27097. Grooved doctor rods may be used here in volumetric dosing, whereas smooth doctor rods are used for hydrodynamic dosing. Doctor blades may also be used for dosing, as shown in WO 02/27097. While the doctor rod makes contact with the application surface in volumetric dosing, the doctor rod or else the doctor blade floats in the case of hydrodynamic dosing without touching the application surface (aquaplaning effect). However, the two dosing principles may also be implemented in other ways. For example, hydrodynamic dosing can also be accomplished using blades as dosing elements.

What is common to all hydrodynamic dosing elements is that they are not in direct contact with the substrate because the hydrodynamic dosing element floats on the liquid film (as in the case of aquaplaning) without touching the surface of the application roll or the substrate.

Volumetric dosing is used predominantly when the application liquids have a very low low-shear viscosity (e.g. <200 mPas Brookfield at 100 rpm) or when the machine speeds are so low (<1000 m/min) that the available hydrodynamic dosing elements cannot generate sufficient hydrodynamics for film formation. Volumetric dosing methods are likewise used when greater film thicknesses (>25 μm) have to be applied directly or indirectly to the fibrous material web.

Hydrodynamic dosing methods are or may be used only when the low-shear viscosity of the application medium is high (e.g. >800 mPas Brookfield) or when the high-shear viscosity of the application medium is high (e.g. >80 mPas, capillary viscometer at high shear rates >1.E-05). In order to be able to employ hydrodynamic dosing, the geometry of the dosing element must be configured such that it can generate sufficient hydrodynamic pressure beneath the dosing element that liquid film can form in the desired film thickness. The greater the contact length between liquid and dosing element and the greater the hydrodynamics generated beneath the dosing element will be. The higher the machine speed or the higher the viscosity, the more hydrodynamics will be generated, such that a broad working window can be achieved for the establishment and control of the wet film thickness.

A common and ever more economically relevant application case for film application is starch application (gluing) by means of a film press. In this case, a starch film is dosed onto the surface of a transfer roll, which then transfers to the fibrous material web in a transfer nip. Particularly in the gluing of packaging papers, there is a trend toward use of transfer rolls having harder surfaces. Such film presses are described, for example, in DE 102018100924A 1 .

A situation that frequently occurs in such applications is that, at low production speeds and/or in the case of the technologically necessary low viscosities of starch solutions, the desired wet film thicknesses cannot be generated with hydrodynamic dosing elements. These necessary film thicknesses can be generated only with volumetric dosing elements.

However, volumetric dosing elements must be in direct contact with the application surface, in the case of the transfer roll. As a result, the dosing elements or the transfer rolls become worn very quickly. As a result, it is also possible to create negative markings in the application profile on the substrate.

It is an object of the invention to overcome the limitations of the hydrodynamic dosing elements.

It is a particular object of the invention to propose hydrodynamic dosing elements that have a much enlarged scope of application compared to the prior art.

It is a further object of the invention to extend the field of use of film presses, especially to the field of hard nip sizing.

Unless explicitly stated otherwise, in the context of this application, the viscosity of the application medium always means the high-shear viscosity measured by capillary viscometer at high shear rates >1.E-05.

The object is achieved in accordance with the invention by a device corresponding to independent claim 1 and a method as claimed in claim 14. Further advantageous embodiments of the present invention can be found in the dependent claims.

With regard to the device, the object is achieved by a device for dosing or levelling a liquid or pasty application medium onto a moving surface. The device comprises a dosing element for contacting of the application medium in a contact zone, and a contact pressure unit for pressing the dosing element against the moving surface. It is envisaged in accordance with the invention that the dosing element consists wholly or partly of a magnetic material, in particular of a ferromagnetic material, and that the device further comprises at least one magnetic element that has a repulsive or attractive effect on the dosing element.

In one embodiment, it may be the case that the magnetic element is arranged such that the magnetic force between the contact pressure unit and the contact zone acts on the dosing element, especially in the region of the contact zone. In this embodiment, it is advantageous when the at least one magnetic element is designed such that the magnetic force counteracts the contact pressure force of the contact pressure unit and the magnetic force especially has an attractive effect on the dosing element. The magnetic force acts as return force for the dosing element.

In a further embodiment, it may be the case that the magnetic force has a repulsive effect on the dosing element, and wholly or partly assumes the function of the contact pressure unit. In such embodiments, it is advantageous when a return force for the dosing element is provided, which counteracts the repulsive magnetic force. This may be achieved by return means, for example a prestressed or bent elastically resilient blade, a prestressed elastic resilient mount of the doctor rod or comparable means.

In the embodiments with repulsive magnetic elements, the magnetic force is essential to the functioning of the dosing device. The repulsive magnets here assume the function of the contact pressure unit. By varying the magnetic force, it is possible to regulate the contact pressure force of the dosing element. A return force, for example via a prestressed or bent elastically resilient blade or a prestressed elastic resilient mount of the doctor rod, can be influenced and delicately regulated by the change in the repulsive magnetic force. In this respect, such an embodiment is very advantageous since the dosing device needs only a few mechanical parts, and is therefore easy and inexpensive to manufacture.

Dosing elements used may be elements known from the prior art, such as dosing blades or dosing elements with doctor rods. It is advantageously possible to use smooth, ungrooved doctor rods. The doctor rods may be hard or soft doctor rods, and the surface thereof may consist, for example, of a rubber, a polyurethane or a metal.

Dosing blades are advantageous for use in a device according to aspects of the invention, since these frequently already consist of a magnetic or ferromagnetic material. But it is also possible in a very simple manner to mount such magnetic or ferromagnetic elements on the dosing devices with doctor rods.

In the case of the dosing devices known from the prior art, it is also possible in the context of the invention to adjust the contact pressure force with which the dosing element is pressed against the moving surface essentially via the contact pressure unit. These contact pressure units are typically mechanical contact pressure units, where the contact pressure force can be generated, for example, by means of adjuster screws, by means of a contact pressure hose or by means of bending.

Especially in the case of use of dosing blades as dosing elements, it is also possible by means of the contact pressure unit to adjust the blade geometry, such as the blade bending and the position of the contact zone.

The contact zone is the region where the dosing element is in contact with the application medium, or the region where the hydrodynamic force acts on the dosing element.

The inventor has recognized that addition of a magnetic field (for example in the form of one or more magnetic elements), especially in the region of this contact zone, allows the contact pressure force to be influenced, especially reduced, in a very accurate and controlled manner.

Especially in the case of hydrodynamic dosing elements, this enables a greatly enlarged field of application. In order to achieve the outlined aquaplaning effect, the force generated by the hydrodynamics must be high enough to compensate for the contact pressure force of the dosing element. This is not possible in many relevant applications owing to low speed or low viscosity of the application medium.

In the case of a reduction in contact pressure force, however, there would be a change in the blade geometry, which is generally undesirable. Moreover, the known contact pressure devices permit only a coarse and relatively inexact adjustment of the contact pressure force.

By means of the magnetic element proposed, it is now possible in a very controlled and also very delicate manner to influence the contact pressure force. The magnetic element acts on the dosing element, which for this purpose must consist of a magnetic or ferromagnetic material or at least comprise an element made of magnetic or ferromagnetic material. This effect may in principle be repulsive or attractive. In order to enable or to assist hydrodynamic dosage, however, it is advantageous when the at least one magnetic element is designed such that the magnetic force counteracts the contact pressure force of the contact pressure unit. In this case, the magnetic element reduces the burden on the contact pressure force exerted by the dosing element on the moving surface to be coated, without any noticeable significant change in geometry in the positioning or in the bending of the dosing element.

A further advantage of this device is that the provision of magnetic elements makes it possible to influence the contact pressure force without noticeably changing the geometry of the dosing element, such as the blade bending or the contact zone. The magnetic field is more likely to change the stiffness of the blade in the case of dosing blades, but hardly likely to deform the blade. The effect of the magnetic element—to an external observer—in the case of hydrodynamic dosing of liquid or pasty films is similar to a (virtual) increase in the viscosity of the application medium.

The proposed solution is also advantageous because it can also be retrofitted in existing systems in a very simple manner. All that has to be done is that the magnetic element has to be added in the holding device of the dosing element. It is likewise possible to guide this magnetic element very delicately with an exact positioning device without any great difficulty. A significant extension of the spectrum of application of coating devices is thus made available to their user at low cost. Since disassembly by removal of the magnetic elements is also very quickly and easily possible, the user also does not enter into any risk at all in retrofitting, which will further increase the acceptance of the new device.

The magnetic element may be designed as an electromagnet or else as a permanent magnet.

It may be the case that the distance of the magnetic element from the dosing element is less than 20 mm, especially less than 10 mm, in particular less than 5 mm. Distances of 1 mm or less are also possible.

In advantageous embodiments, it may be the case that the magnetic force that acts on the dosing element is controllable. In particular, it may also be the case that the effect of the magnetic force on the dosing element can be wholly or largely switched off.

In the case of use of suitable electromagnets, such control is possible in a very simple manner via control of current. But it is also possible to control the magnetic force when permanent magnets are used. For example, it may be the case that the distance of the magnetic element from the dosing element is adjustable.

In principle, for such an adjustment, a manually operable adjusting device is conceivable. For such an adjustment of the distance, however, it is advantageous when at least one servo motor is used to adjust the distance of the magnetic element from the dosing element. Such servo motors, in particular linear servo motors, can achieve very exact and delicate adjustment of the distance. Movement of the magnets in the μm range or in the 1/10 mm range relative to the magnetic or ferromagnetic part of the dosing element is possible here, which means that it is possible to reduce or increase the magnetic force acting on the dosing element in very small steps. It is therefore possible to reduce the burden on the dosing element via the magnetic force in very fine steps.

Such very delicate alteration of the contact pressure force via the contact pressure element would not be possible with the contact pressure elements that are now customary.

The dosing elements in modern plants, for example paper machines, may extend over 10 m or more. In order to enable uniform control of the force on the dosing element, it is advantageous when the magnetic element extends over the entire length of the dosing element (in machine cross direction).

Such a long magnetic element can be achieved in various ways. For example, the magnetic element may be designed as a continuous magnetic strip. Alternatively, the magnetic element may be formed from multiple individual magnets arranged alongside one another. The distances between these individual magnets may be matched to the type of dosing element and the materials used. Frequently, the distances between two adjacent magnets are 10 mm or more, especially 20 mm or more. When magnetic dosing bars are used (assembled from multiple magnetic segments in a row), the pitch (and hence the distance between adjacent magnetic segments) may be in the range from 50 mm to 100 mm, or in individual cases more than 100 mm.

It is particularly advantageous when means of profiling the magnetic force over the length of the dosing element, and hence with the device installed, in machine cross direction are provided. Moreover, very precise profiling of the active contact pressure force on the moving surface is possible. These means may be achieved, for example, in that, when two or more individual magnets are used, two or more and especially all these magnets are provided with a servo motor in order to adjust the distance of the magnets from the dosing element. Alternatively, it is also possible to use a multitude of electromagnets, where the magnetic force can be varied independently, for example, by variation of current. Alternatively, manual adjustment via a spindle with a fine spindle flight is also possible.

In preferred embodiments, it may be the case that the magnetic force per cm is between 0.01 g/cm and 10 kg/cm, preferably between 0.1 g/cm and 10 kg/cm, especially between 0.05 g/cm and 5 kg/cm, more preferably between 0.5 g/cm and 3 kg/cm. It is particularly advantageous when the magnetic force on the dosing element can be varied within the ranges specified-for example by variation of the distance of the magnetic element from the dosing element.

In order to enable stable operation of the device, it is advantageous when the magnetic or ferromagnetic material used does not lose its (ferro)magnetic properties even if there is an elevated temperature at the site of use-for example as a result of an operating error or exceptional production situations. In preferred embodiments, it may therefore be the case that the Curie temperature (Tc) of the magnetic or ferromagnetic material is at least 80° C., especially at least 100° C. This is advantageous especially when the application medium used is a starch solution. This has to be heated prior to application. Depending on starch used (wheat/potato/corn/rye starch), the temperature level required for gelatinization is different, the consequence of which is that the level of heating of the dosing element by contact with the starch may also be different. At a Curie temperature of above 80° C., especially of above 100° C., the dosing element can, however, be used for all standard types of starch without any risk of loss of magnetic properties of the magnetic or ferromagnetic material, and hence malfunctioning of the dosing device.

As well as iron (T_{C}=759° C.) and nickel (T_{C}=353° C.), CrO2 (T_{C}=116° C.), for example, also has an appropriate Curie temperature. Neodymium magnets can be established with Curie temperatures of above 100° C. Therefore, these materials in particular are suitable for use as magnetic or ferromagnetic material for the dosing element.

Neodymium magnets are particularly suitable since these are able to provide high magnetic forces with small material volume, which enables a compact design of the application device.

With regard to the method, the object is achieved by a method of dosing or levelling a liquid or pasty application medium onto a moving surface, where the application medium is first applied to the moving surface and then is dosed or levelled by means of a device, wherein the device is designed according to one aspect of the invention.

The moving surface may be a material web to be coated, for example a web of paper, packaging material or cardboard (“direct coating”). Alternatively, the moving surface may also be the surface of a transfer element, especially a transfer roll, from which the application medium is then transferred to the material web.

In advantageous embodiments of the method, it may be the case that the application medium has a high-shear viscosity of less than 80 mPas and/or a film is dosed with a film thickness between 5 μm and 100 μm, especially between 5 m and 50 μm.

A particularly preferred embodiment is the use of a starch solution as application medium.

Alternatively, application media used may, for example, also be low-viscosity application liquids for production of barrier layers (water vapor barrier, grease barriers, oxygen barriers, bacterial barriers, light barriers, etc.).

The benefits of a device in one aspect of the invention are manifested in particular when such a device is used for dosing or levelling off a liquid or pasty application medium onto a moving surface, where the moving surface is the surface of a roll, and where the surface has a Shore D hardness between 60-100, preferably between 80-95. Such rolls are finding increasing use in the field of starch application. In what is called hard nip sizing, a starch solution is dosed onto two hard rolls in a film press, and these then transfer the starch onto a fibrous material web in a transfer nip formed from the two rolls.

In the case of such hard surfaces, the use of dosing systems that come into contact is undesirable owing to high wear. Therefore, contactless hydrodynamic dosing has particularly major benefits here. The devices proposed here can achieve a distinct increase in the field of application compared to that by means of hydrodynamic dosing to date. The field of use of film presses in the field of hard-nip sizing is distinctly broadened as a result.

In the case of dosing onto the surface of a rotating roll, especially a hard roll having surface Shore D hardnesses between 60-100, it is very advantageous when radial runout is very small, and especially in the region of ≤40 μm. This is very advantageous for stable hydrodynamic dosing of a uniform film thickness.

In the case of dosing onto a rotating roll, the application medium can be transferred from the roll surface by means of a transfer nip to a fibrous material web-for example a web of paper, cardboard or packaging material. This is referred to as indirect application.

Alternatively, the application medium can be dosed directly onto a fibrous material web as moving surface. In this direct application to the surface of a fibrous material web, the latter may especially be run on a roll in the application region.

In direct and in indirect application, the fibrous material web may have a weight per unit area of between 20 and 400g/m², preferably between 40-120 g/m².

The moving surface may have a speed of more than 1000 m/min, especially more than 1500 m/min, preferably 1800 m/min or more.

The invention is elucidated hereinafter with reference to figures. This invention is not restricted to these embodiments. The specific figures show:

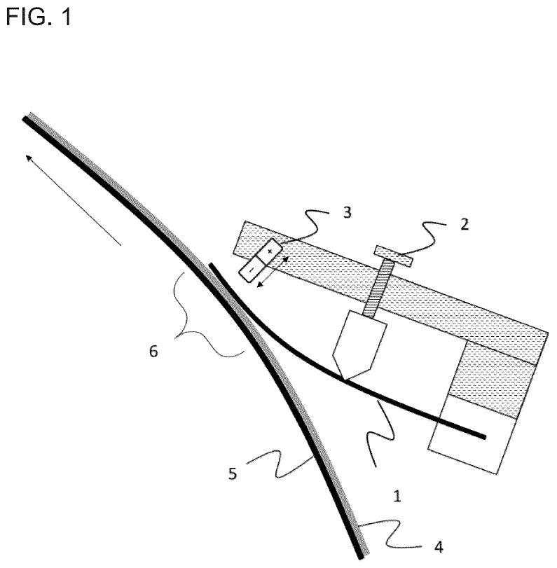

FIG. 1 shows a device for dosing and levelling in one aspect of the present invention.

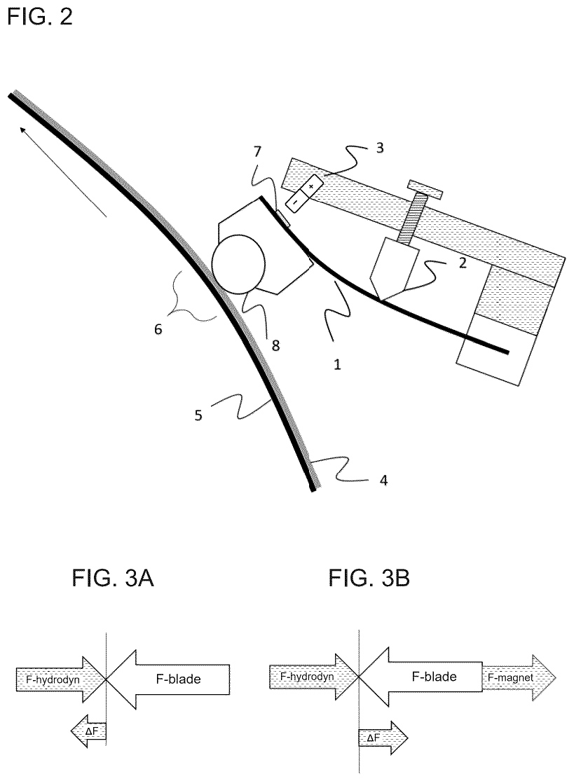

FIG. 2 shows a device for dosing and levelling in a further aspect of the present invention.

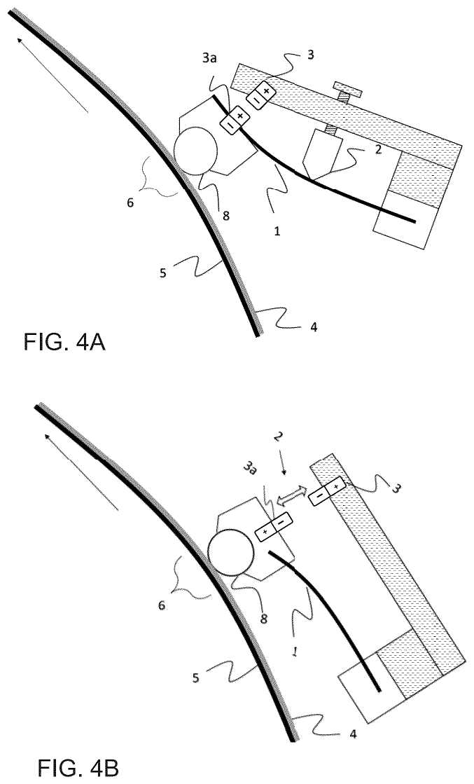

FIGS. 3 a and 3 b show a schematic of one aspect of the mode of action in one variant of the present invention.

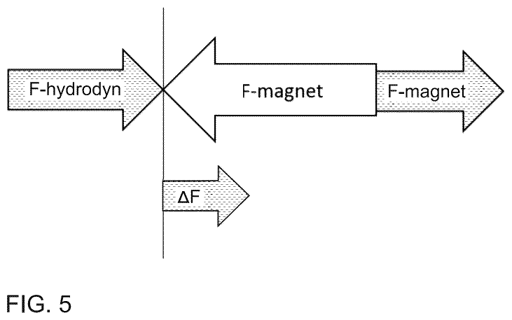

FIGS. 4 a and 4 b a device for dosing and levelling in further aspects of the present invention.

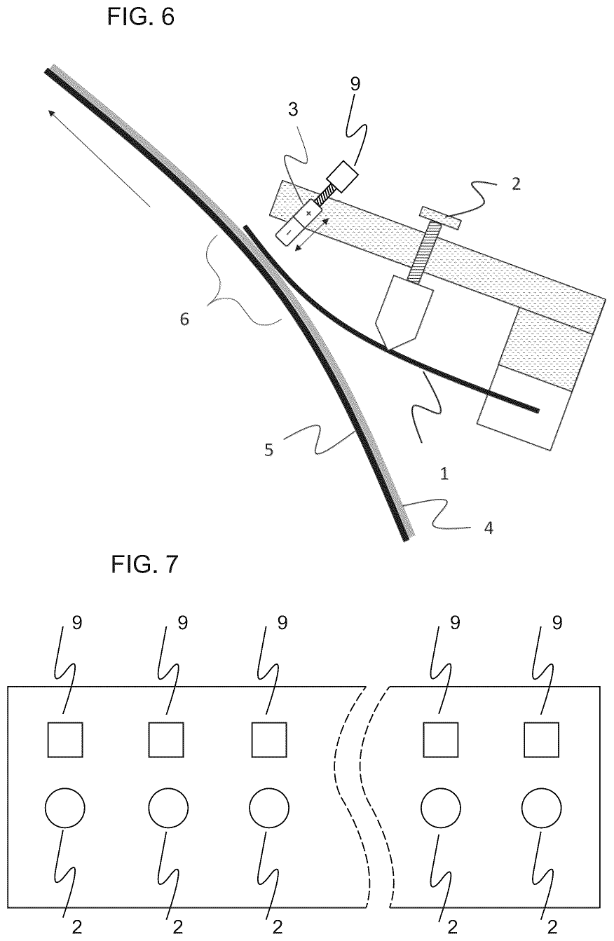

FIG. 5 shows a schematic of one aspect of the mode of action in a further variant of the present invention.

FIG. 1 shows a device in one aspect of the invention. In this embodiment, the dosing element 1 used is a dosing blade 1. This dosing blade 1 is pressed against the moving surface 5 by means of a contact pressure unit 2. The contact pressure unit 2 is implemented here as a mechanical contact pressure unit 2, where the contact pressure is controlled by means of an adjuster screw. A multitude of such adjuster screws are arranged over the length of the dosing element 1, in order to enable profiling of the contact pressure force. Alternatively, however, other implementations of the contact pressure unit 2 are also possible and in use.

An application medium 4 is applied to the moving surface 5 by means of an application unit which is not shown explicitly. The dosing blade 1 is in contact with the application medium 4 in a contact zone 6. If the application medium 4 is applied in excess, the dosing blade 1 can remove the excess application medium 4, such that only the desired amount remains dosed on the moving surface 5. Alternatively or additionally, the blade 1 can also level out the application medium 4 over the length of the dosing element 1.

Additionally provided in the device is a magnetic element 3. This magnetic element 3 is arranged such that the magnetic force between the contact pressure unit 2 and the contact zone 6—directly in the region of the contact zone 6 in FIG. 1 acts on the dosing element 1. In the embodiment shown in FIG. 1, the entire dosing element 1 is manufactured in the form of a dosing blade 1 made from a magnetic or ferromagnetic material. Alternatively or additionally, it may also be the case that an element made from a magnetic or ferromagnetic material is mounted on the dosing element 1 in the region of the contact zone 6.

The magnetic element 3 may be implemented by means of electromagnets or permanent magnets. A multitude of such magnets may be arranged alongside one another over the length of the dosing element 1 in order to enable profiling. Alternatively, the magnetic element 3, however, may also be designed, for example, as a continuous magnetic strip 3.

Neodymium magnets are particularly suitable since these are capable of providing high magnetic forces with small material volume, which enables a compact design of the application device.

Advantageously, the magnetic force that acts on the dosing element 1 is controllable. In the embodiment in FIG. 1, this is achieved in that the distance of the magnetic element 3 from the dosing element 1 is adjustable. This can be accomplished, for example, by means of suitable servo motors, for example linear servo motors.

FIG. 2 shows an alternative implementation of a device according to aspects of the present invention. The dosing element 1 here, by contrast with FIG. 1, is not a dosing blade 1. The dosing is instead effected by means of a doctor rod 8 mounted rotatably in a mount. FIG. 2 here too shows an implementation of hydrodynamic dosing. For this purpose, the doctor rod 8 advantageously takes the form of a smooth doctor rod 8. This makes contact with the application medium 4 in a contact zone 6, but not directly with the moving surface 5 on hydrodynamic application. The mounts for the doctor rod 8 are frequently manufactured from a nonmagnetic polymer material. In order nevertheless to enable the effect of the magnetic force of the magnetic element 3 on the dosing element 1, an additional element made from magnetic or ferromagnetic material 7 is provided here by way of example, which is especially mounted on the dosing element 1 in the region of the contact zone.

The same applies to the configuration of the contact pressure unit 2 and of the magnetic element 3 as to the corresponding elements in FIG. 1.

FIGS. 3 a and 3 b are intended to once again by way of example show one aspect of the mode of operation of an embodiment of the present invention. FIG. 3 a shows the force situation in the contact zone 6. The contact pressure force F-blade of a dosing blade 1 acts here in the direction of the moving surface 5, while the hydrodynamic force F-hydrodyn of the application medium acts in the opposite direction. This frequently results in a very low film thickness, for example in the case of application media 4 having a low high-shear viscosity, because an additionally low speed of the moving surface 5 means that the resultant force ΔF exceeds the hydrodynamic force in the direction of the blade force F-blade. Thus, this resulting force ΔF is directed in the direction of the moving surface 5 and will reduce the film thickness to such an extent that an equilibrium is established. This does not result in the desired floating of the dosing element 1 (“aquaplaning”), and the dosing element 1 can even make contact with the moving surface 5 because no “lubrication film” is formed.

In devices according to aspects of the present invention, it is now the case, as shown in FIG. 3 b, that there is an additional force component with the magnetic force F-magnet. This acts in the same direction as the hydrodynamic force F-hydrodyn. The magnetic force F-magnet can then advantageously be adjusted such that the resulting force ΔF is no longer directed in the direction of the blade force F-blade, but rather in the direction of the hydrodynamic force F-hydrodyn. An adjustment in the magnetic force F-magnet allows the resulting force ΔF to be adjusted very accurately in embodiments according to aspects of the invention, in order, for example, to achieve a desired film thickness in spite of low viscosity of the application medium 4 or low speed of the moving surface 5.

FIGS. 4 a and 4 b show further possible implementations of a device according to aspects of the present invention. The device from FIG. 4 a corresponds largely to the device from FIG. 2. The element made from magnetic or ferromagnetic material 7 has merely been replaced by a further magnetic element 3a. The two magnetic elements 3, 3a are arranged relative to one another such that the two magnetic elements 3, 3a attract one another. The mode of operation of this embodiment is thus essentially analogous to the embodiment in FIG. 2. However, the further magnetic element 3a, by comparison with the element made from magnetic or ferromagnetic material 7, increases the active magnetic force.

The device in FIG. 4 b also replaces the element made from magnetic or ferromagnetic material 7 with a further magnetic element 3a. By contrast with FIG. 4 a, the magnetic elements 3, 3a are arranged relative to one another in FIG. 4 b such that the magnetic elements repel one another.

In the embodiment according to FIG. 4 a, the dosing element 1 is pushed in the direction of the moving surface 5 by means of a contact pressure unit 2. The attractive effect of the magnetic element 3, 3a acts counter to this blade force and reduces the load on the dosing element 1. In these embodiments, the magnetic force thus acts in the direction of hydrodynamic force, whereas the blade force acts counter to the hydrodynamic force.

In embodiments as shown in FIG. 4 b, the magnetic force acts counter to the hydrodynamic force. For this purpose, the dosing unit 1 is designed such that the blade force acts in the direction of the hydrodynamic force. The dosing unit 1 has a blade/spring portion which is intended to push the dosing unit 1 away from the moving surface 5. The function of the contact pressure unit 2 is adopted by the repulsive magnetic elements 3, 3a.

FIG. 5 shows a schematic of the mode of operation of an in FIG. 4 b execution of the invention. Here too, the magnetic force F-magnet again acts against the blade force F-blade. Here too, the magnetic force F-magnet can be very delicately adjusted, such that the resulting force ΔF composed of F-magnet on the one hand and F-blade and hydrodynamic force F-hydrodyn on the other hand have the desired value.

In the embodiments according to FIG. 1, 2 or 4 a, the attractive magnetic force F-magnet serves exclusively to adjust the resulting force ΔF. In the embodiments with repulsive magnetic elements 3, 3a, the magnetic force F-magnet is essential to the working of the dosing device. The repulsive magnets 3, 3a assume the function of the contact pressure unit 2 here. Changing the position of the magnet 3 compared to the position of the repulsive magnet 3a allows regulation of the contact pressure force of the dosing element 1. A prestressed or bent elastically resilient blade or a prestressed elastic resilient mount of the doctor rod can be influenced and delicately regulated by the change in the repulsive magnetic force F-magnet. In this respect, such an embodiment is very advantageous since the dosing device needs fewer mechanical parts and is therefore easier and cheaper to manufacture.

In the case of embodiments with attractive magnets or an attractive magnet and ferromagnetic doctor element, it may in principle be the case that magnetic element 3 and doctor element 7 have too strong a mutual attraction, resulting in abrupt jumping and sticking of the ferromagnetic doctor element to the magnet. This state is undesirable.

This can occur when the distance between magnetic element 3 and the ferromagnetic or magnetic doctor element 7 goes below a particular minimum level. This behavior cannot occur in embodiments with repulsive magnets since the repulsive force rises when the distance between the magnets 3, 3a is reduced.

### LIST OF REFERENCE NUMERALS

1 dosing element
2 contact pressure unit
3 magnetic element
3a magnetic element
4 application medium
5 moving surface
6 contact zone
7 element made from magnetic or ferromagnetic material
8 doctor rod

1-16. (canceled)

17. A device for dosing or levelling a liquid or pasty application medium onto a moving surface, the device comprising:
a dosing element for contacting the application medium in a contact zone, said dosing element being formed wholly or partly of a magnetic or ferromagnetic material;
a contact pressure unit for pressing said dosing element against the moving surface; and
at least one magnetic element having a repulsive effect on said dosing element, said at least one magnetic element exerting a controllable magnetic force acting on said dosing element.

18. The device according to claim 17, wherein said magnetic force having said repulsive effect on said dosing element wholly or partly assumes a function of said contact pressure unit.

19. The device according to claim 18, wherein said dosing element has a return device being a prestressed or bent elastically resilient blade or a prestressed elastic resilient mount of a doctor rod, counteracting said repulsive magnetic force.

20. The device according to claim 17, wherein said at least one magnetic element includes a plurality of magnetic elements, at least one of said plurality of magnetic elements has said repulsive effect on said dosing element, and at least one of said plurality of magnetic elements has an attractive effect on said dosing element.

21. The device according to claim 17, wherein said dosing element includes a dosing blade or a doctor rod.

22. The device according to claim 17, wherein said at least one magnetic element is disposed at an adjustable distance from said dosing element.

23. The device according to claim 22, which further comprises at least one servo motor or linear servo motor for adjusting said adjustable distance of said at least one magnetic element from said dosing element.

24. The device according to claim 17, wherein said at least one magnetic element is disposed at a distance of less than 20 mm from said dosing element.

25. The device according to claim 17, wherein said at least one magnetic element is disposed at a distance of less than 5 mm from said dosing element.

26. The device according to claim 17, wherein said at least one magnetic element is disposed at a distance of 1 mm or less from said dosing element.

27. The device according to claim 17, wherein said at least one magnetic element extends over an entire length of said dosing element along a cross direction of the device.

28. The device according to claim 17, which further comprises a device for profiling magnetic force over a length of said dosing element.

29. The device according to claim 17, wherein said controllable magnetic force per cm is between 0.01 g/cm and 10 kg/cm.

30. The device according to claim 17, wherein said controllable magnetic force per cm is between 0.05 g/cm and 5 kg/cm.

31. The device according to claim 17, wherein said controllable magnetic force per cm is between 0.5 g/cm and 3 kg/cm.

32. The device according to claim 17, wherein said wholly or partly magnetic or ferromagnetic material has a Curie temperature of at least 80° C.

33. The device according to claim 17, wherein said wholly or partly magnetic or ferromagnetic material has a Curie temperature of at least 100° C.

34. A method of dosing or levelling a liquid or pasty application medium onto a moving surface, the method comprising:
initially applying the application medium to the moving surface; and
then dosing or levelling the application medium by using the device according to claim 17.

35. The method according to claim 34, which further comprises at least one of:
providing the application medium with a high-shear viscosity of less than 80 mPas, or
dosing a film with a film thickness between 5 μm and 100 μm.

36. The method according to claim 34, which further comprises at least one of:
providing the application medium with a high-shear viscosity of less than 80 mPas, or
dosing a film with a film thickness between 5 μm and 50 μm.

37. A method of dosing or levelling a liquid or pasty application medium onto a moving surface, the method comprising:
providing a roll having the moving surface with a Shore D hardness between 60-100; and
using the device according to claim 17 for dosing or levelling of the liquid or pasty application medium onto the moving surface of the roll.

38. The method according to claim 37, which further comprises providing the moving surface with a Shore D hardness between 80-95.
